(19) United States
(12) Patent Application Publication
(10) Pub. No.: US 2017/0109537 A1
(43) Pub. Date: Apr. 20, 2017

(54) VORRICHTUNG, DIE ZUGRIFFSSCHUTZ FUER STRUKTURHALTIGE VERTEILTE DATEN REALISIERT

(71) Applicant: Fraunhofer-Gesellschaft zur Foerderung der angewandten Forschung e.V., Muenchen (DE)

(72) Inventors: Florian Patzer, Karlsruhe (DE); Andreas Jakoby, Luebeck (DE); Thomas Kresken, Stutensee (DE)

(21) Appl. No.: 14/817,035

(22) Filed: Oct. 16, 2015

(51) Int. Cl. G06F 21/60; G06F 17/30; G06F 21/31

(52) U.S. Cl. CPC G06F 21/602; G06F 21/31; G06F 17/30194; G06F 17/30994

(57) ABSTRACT

A device for accessing metadata information of a file system is provided. The device includes an interface and a processor. The interface is configured to load encrypted edge metadata from a storage. The processor is configured to decrypt the encrypted edge metadata in order to obtain decrypted edge metadata, having information on a storage location of encrypted node metadata and a node decryption key. The interface is configured to load the encrypted node metadata from the storage using the information on the storage location of the encrypted node metadata. The processor is configured to decrypt the encrypted node metadata using the node decryption key in order to obtain decrypted node metadata.

### BACKGROUND OF THE INVENTION

The application relates to a device realizing access protection for structural distributed data.

In known technology, distributive file systems are employed in data processing centers or even across data processing centers. Thus, a file system is implemented on all the servers involved. The support of different file systems in the known technology is realized by means of virtual distributed file systems. These necessitate virtualization software to be installed and configured which entails high costs. When using the storage of external providers, as offered by STaaS (storage as a service) service providers, in addition to its own storage is desired, another file system has to be managed and used in parallel. Usually, there is no way of uniting the storage of an STaaS service and the own storage or that of another STaaS service provider to form one system. This will necessitate a high degree of cooperation between the service-managing parties involved since this all takes place within a non-standardized domain.

There are client programs allowing simultaneous usage of different cloud services. A number of such programs offer different STaaS services to be integrated simultaneously. However, the services here are separated from one another entirely. The user has to know which service data have been stored on.

In addition, some of these programs offer a certain degree of security by encrypting the data on the client side. However, the keys are available on the peripherals and may, thus, potentially be stolen.

Furthermore, only a single key is used in existing solutions on the client side for encrypting data. However, this does not protect the data sufficiently. Compromising the key will result in compromising the entire data stock. Such a deficiency in security is unacceptable for sensitive data. Data are exemplarily to be considered to be sensitive when demanding a high degree of confidentiality. Examples of sensitive data are, among other things, police or secret service documents.

In addition, using different apparatuses necessitates a key to be passed on or handing over its own key to the solution provider so that same may be loaded from the server thereof at a different place. Passing on the key is complicated and sometimes not understandable for a person or an organization of little technical experience. When the key is managed by the provider, security of the data cannot be ensured since an STaaS provider should not be trusted when dealing with sensitive data.

When storage services from different providers are to be used in combination, maybe even storage from its own sphere of influence is to be integrated into this combination and sufficient confidentiality of the data ensured, a number of questions have to be solved:

Combining the distributed storages is desirable on the one hand. The storages used are spatially separated from one another. Such a storage combination consists of different data carriers which may run on heterogeneous computer systems. Frequently, these are located in different data processing centers which may be distributed all over the world. The difficulty here is combining these distributed storages. This process is complicated by the heterogeneity of the file systems used.

On the other hand, heterogeneous file systems are to be combinable. The storages to be combined here may exemplarily consist of different file systems. Standardizing these file systems, however, conflicts with the fact that at least part of them evades the sphere of influence of the combining party (exemplarily the system of a storage service provider). The combining party may exemplarily be a person or a group of people constructing a file system or container including distributed storage.

In addition, usability needs to be realized as a single file system. Up to now, it is up to the users to manage, when simultaneously using several storage services, each individual one. Frequently, the result is only one of the systems to be used. Apart from eliminating, adding, editing and renaming the data, administering same as to access rights is also part of managing the services.

In addition, confidentiality of the data is to be ensured. Employees of companies and authorities are generally prohibited from storing professional data on foreign systems in an unencrypted manner. In order to keep confidentiality, these are encrypted even before being uploaded to such a system. Exemplarily, a system may be considered to be foreign when not being located within the sphere of influence of the combining party, meaning that same may not necessarily amend its services and protocols.

In addition, confidentiality of the metadata also is to be ensured. Protecting the metadata of a datum is not ensured in distributed file systems as soon as a foreign system is able to read same out. For this reason, the metadata are encrypted before uploading, the result being that the file system cannot be managed by the integrated, foreign storage services.

Finally, protection of the cryptosystem is to be realized. Since potentially insecure peripherals are used, when executing cryptographic operations on the peripherals, there may be an unwanted flow of information. Keys may be stolen here, which endangers the present and future security of the entire cryptosystem.

All these objectives are in close technical connection. Realizing these or at least some of these individual objectives which are closely interleaved with one another, is particularly desirable.

An overall solution for all these objectives is not known from the known technology.

As far as virtual distributive file systems are concerned, systems such as Tahoe LAFS (see https://www.tahoe-lafs.org/trac/tahoe-lafs) allow several different distributive file systems to be combined. However, this is limited to such systems located within the sphere of influence of the combining party. Thus, these systems address the problem of combining distributed storages, the problems of combining heterogeneous systems and realizing as a file system, however, is addressed only insufficiently. Such systems sometimes also solve the problem of keeping data confidential by employing encryption on the user side. The problem of keeping the metadata confidential and the problem of protecting the crypto system, however, are not solved here.

Upstream services in combination with combiners on the user side are, for example, products such as Unifyle (see http://www.unifyle.co/, a product by the company Primadesk Inc.) and offer a service to be integrated by the company, allowing the use of company storage, like STaaS storage services. When a user additionally uses a combiner application (like CloudFuze, see https://www.cloudfuze.com/; Primadesk, see https://primadesk.com/), which combines STaaS storage services, the problems of combining several different distributive file systems and combining heterogeneous systems are solved. However, no variation of these combiner applications is known, which solves the problem of realizing usability as a file system, since these programs only generate virtual mappings of the STaaS storages, but do not implement file system logic. With some of these systems, the data are encrypted on the user side, thereby solving the problem of keeping the data confidential. The problem of keeping the metadata confidential and the problem of protecting the cryptosystem are not solved here either. In the case of Primadesk, the metadata are even stored on the company servers in an redundant and unencrypted manner so as to allow search functions.

Protecting the cryptosystem may be solved using a confidential environment, wherein there is no unencrypted key outside the environment. The possibility of keeping the metadata confidential, however, cannot be achieved. Usability as a file system and protection of the cryptosystem are realized only to a limited extent but not completely.

### SUMMARY

According to an embodiment, a device for accessing metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, may have: an interface and a processor, wherein the interface is configured to load encrypted edge metadata of an edge of the plurality of edges from the storage, wherein the processor is configured to decrypt the encrypted edge metadata of the edge of the plurality of edges in order to obtain decrypted edge metadata of the edge of the plurality of edges, including at least a node decryption key of a node of the plurality of nodes and information on a storage location of the encrypted node metadata of the node of the plurality of nodes in the storage, the node of the plurality of nodes being the predecessor node or successor node of the edge of the plurality of edges, wherein the interface is configured to load the encrypted node metadata of the node of the plurality of nodes from the storage using the information on the storage location of the encrypted node metadata of the node of the plurality of nodes, and wherein the processor is configured to decrypt the encrypted node meta data of the node of the plurality of nodes using the node decryption key of the node of the plurality of nodes in order to obtain decrypted node metadata of the node of the plurality of nodes.

According to another embodiment, a system realizing access to metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, may have: one or more devices as mentioned above, and a storage, wherein the interface of each of the one or more devices is configured to load encrypted edge metadata of an edge of the plurality of edges of the metadata information from the storage, wherein the processor of each of the one or more devices is configured to decrypt the encrypted edge metadata of the edge of the plurality of edges in order to obtain decrypted edge metadata of the edge of the plurality of edges, having at least a node decryption key of a node of the plurality of nodes and information on a storage location of encrypted node metadata of the node of the plurality of nodes in the storage, the node of the plurality of nodes being the predecessor node or successor node of the edge of the plurality of edges, wherein the interface of each of the one or more devices is configured to load the encrypted node metadata of the node of the plurality of nodes from the storage using the information on the storage location of the encrypted node metadata of the node of the plurality of nodes, and wherein the processor of each of the one or more devices is configured to decrypt the encrypted node metadata of the node of the plurality of nodes using the node decryption key of the node of the plurality of nodes in order to obtain decrypted node metadata of the node of the plurality of nodes.

According to another embodiment, a non-volatile storage, a plurality of nodes and a plurality of edges defining a hierarchy of a file system, each edge of the plurality of edges being defined by a predecessor node and a successor node from the plurality of nodes each, each node of the plurality of nodes being associated to either a directory of the file system or a file of the file system, may have: a plurality of storage cells, and a storage interface for accessing the plurality of storage cells, wherein edge metadata are stored in the non-volatile storage for each edge of the plurality of edges in an encrypted manner, wherein node metadata are stored in the non-volatile storage for each node of the plurality of nodes in an encrypted manner, wherein the edge metadata of each edge of the plurality of edges have, for at least one node of the plurality of nodes which is the predecessor node or the successor node of this edge, at least a node decryption key for decrypting the node metadata of this node and information on a storage location of the node metadata of this node in the non-volatile storage, and wherein the node metadata of each node of the plurality of nodes have, for at least one edge of the plurality of edges for which this node is the predecessor node or the successor node, at least an edge decryption key for decrypting this edge and information on a storage location of the encrypted edge metadata of this edge in the non-volatile storage.

According to still another embodiment, a method for accessing metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, may have the steps of: loading encrypted edge metadata of an edge of the plurality of edges from a storage, decrypting encrypted edge metadata of the edge of the plurality of edges in order to obtain decrypted edge metadata of the edge of the plurality of edges, having at least a node decryption key of a node of the plurality of nodes and information on a storage location of encrypted node metadata of the node of the plurality of nodes in the storage, wherein the node of the plurality of nodes is the predecessor node or the successor node of the edge of the plurality of edges, loading the encrypted node metadata of the node of the plurality of nodes from the storage using the information on the storage location of the encrypted node metadata of the node of the plurality of nodes, and decrypting the encrypted node metadata of the node of the plurality of nodes using the node decryption key of the node of the plurality of nodes in order to obtain decrypted node metadata of the node of the plurality of nodes.

Another embodiment may have a non-volatile computer-readable medium having a computer program, the computer program implementing a method as mentioned above when the computer program is executed on a computer.

A device for accessing metadata information of a file system is provided. The device includes an interface and a processor. The interface is configured to load encrypted edge metadata from a storage. The processor is configured to decrypt the encrypted edge metadata to obtain decrypted edge metadata which include information on a storage location of encrypted node metadata and a node decryption key. The interface is configured to load the encrypted node metadata from the storage using the information on the storage location of the encrypted node metadata. The processor is configured to decrypt the encrypted node metadata using the node decryption key in order to obtain decrypted node metadata.

In particular, a device for accessing metadata information of a file system is provided. A plurality of nodes and a plurality of edges define a hierarchy of the file system, each edge of the plurality of edges being defined by a predecessor node and a successor node from the plurality of nodes each, wherein each node of the plurality of nodes is associated to either a directory of the file system or a file of the file system. The device includes an interface and a processor. The interface is configured to load encrypted edge metadata of an edge of the plurality of edges from a storage. The processor is configured to decrypt the encrypted edge metadata of the edge of the plurality of edges in order to obtain decrypted edge metadata of the edge of the plurality of edges, comprising at least a node decryption key of a node of the plurality of nodes and information on a storage location of encrypted node metadata of the node of the plurality of nodes in the storage, wherein the node of the plurality of nodes is the predecessor node or the successor node of the edge of the plurality of edges. Additionally, the interface is configured to load the encrypted node metadata of the node of the plurality of nodes from the storage using the information on the storage location of the encrypted node metadata of the node of the plurality of nodes. Furthermore, the processor is configured to decrypt the encrypted node metadata of the node of the plurality of nodes using the node decryption key of the node of the plurality of nodes in order to obtain decrypted node metadata of the node of the plurality of nodes.

In accordance with an embodiment, the device exemplarily also includes an output unit which is a screen unit, a sound output unit or a printer. The decrypted node metadata of the node of the plurality of nodes exemplarily include a directory name of the directory which the node is associated to or, for example, a file name of the file which the node is associated to. The output unit is, for example, configured to output the directory name or the file name.

In one embodiment, the decrypted node metadata of the node of the plurality of nodes exemplarily include information on a storage location of the file which the node is associated to. The interface is, for example, configured to load, using the information on the storage location of the file which the node of the plurality of nodes is associated to, the file which the node of the plurality of nodes is associated to from the storage. The processor is, for example, configured to output the file which the node of the plurality of nodes is associated to.

In accordance with an embodiment, the device is, for example, configured to obtain the decrypted edge metadata of the edge of the plurality of edges by configuring the processor to decrypt further encrypted node metadata of another node of the plurality of nodes in order to obtain further decrypted node metadata, wherein the further node is either the predecessor node or the successor node of the edge of the plurality of edges, wherein the further decrypted metadata include at least an edge decryption key of the edge of the plurality of edges and information on a storage location of the encrypted edge metadata of the edge of the plurality of edges in the storage. The interface is, for example, configured to load the encrypted edge metadata of the edge of the plurality of edges from the storage using the information on the storage location of the encrypted edge metadata of the edge of the plurality of edges. The processor is, for example, configured to decrypt the encrypted edge metadata of the edge of the plurality of edges using the edge decryption key of the edge of the plurality of edges in order to obtain the decrypted edge metadata of the edge of the plurality of edges.

In one embodiment, the interface is, for example, configured to load an authorization key for the edge of the plurality of edges when a user is authorized to access the successor node of the edge of the plurality of edges, or the interface is, for example, configured to load an authorization key for the edge of the plurality of edges when the user is authorized to access the predecessor node of the edge of the plurality of edges. The processor is, for example, configured to decrypt the encrypted edge metadata using the edge decryption key and the authorization key of the edge of the plurality of edges in order to obtain the decrypted edge metadata of the edge of the plurality of edges.

In accordance with an embodiment, the interface is, for example, configured not to load an authorization key for the edge of the plurality of edges when the user is not authorized to access the successor node of the edge of the plurality of edges, or the interface is, for example, configured not to load an authorization key for the edge of the plurality of edges when a user is not authorized to access the predecessor node of the edge of the plurality of edges. The processor is, for example, configured not to decrypt the encrypted edge metadata of the edge of the plurality of edges when the user is not authorized to access the successor node of the edge of the plurality of edges, or the processor is, for example, configured not to decrypt the encrypted edge metadata of the edge of the plurality of edges when the user is not authorized to access the predecessor node of the edge of the plurality of edges.

In one embodiment, the processor is, for example, configured to decrypt the encrypted edge metadata of the edge of the plurality of edges by the processor decrypting the encrypted edge metadata using the edge decryption key of the edge of the plurality of edges in order to obtain first encrypted intermediate data of the edge of the plurality of edges and by the processor decrypting the first encrypted intermediate data using the authorization key of the edge of the plurality of edges in order to obtain the decrypted edge meta data of the edge of the plurality of edges.

In accordance with one embodiment, the processor is, for example, configured to decrypt the encrypted edge metadata of the edge of the plurality of edges by the processor decrypting the encrypted edge metadata using the authorization key of the edge of the plurality of edges in order to obtain second encrypted intermediate data of the edge of the plurality of edges, and by the processor decrypting the second encrypted intermediate data using the edge decryption key of the edge of the plurality of edges in order to obtain the decrypted edge metadata of the edge of the plurality of edges.

In one embodiment, the storage is a non-volatile storage, for example.

In addition, a system realizing access to metadata information of a file system is provided. A plurality of nodes and a plurality of edges define a hierarchy of the file system, wherein each edge of the plurality of edges is defined by a predecessor node and a successor node from the plurality of nodes each, wherein each node of the plurality of nodes is associated to either a directory of the file system or a file of the file system. The system includes one or more of the devices described before and a storage.

The interface of each of the one or more devices is configured to load encrypted edge metadata of an edge of the plurality of edges of metadata information from the storage.

The processor of each of the one or more devices is configured to decrypt the encrypted edge metadata of the edge of the plurality of edges in order to obtain decrypted edge metadata of the edge of the plurality of edges, including at least one node decryption key of a node of the plurality of nodes and information on a storage location of encrypted node metadata of the node of the plurality of nodes in the storage, wherein the node of the plurality of nodes is the predecessor node or the successor node of the edge of the plurality of edges. In addition, the interface of each of the one or more devices is configured to load the encrypted node metadata of the node of the plurality of nodes from the storage using the information on the storage location of the encrypted node metadata of the node of the plurality of nodes. Furthermore, the processor of each of the one or more devices is configured to decrypt the encrypted node metadata of the node of the plurality of nodes using the node decryption key of the node of the plurality of nodes in order to obtain decrypted node metadata of the node of the plurality of nodes.

In accordance with an embodiment, the system particularly includes, for example, two or more of the devices described before.

In one embodiment, the storage, for example, includes two or more sub-storages. Additionally, the system exemplarily comprises two or more casings, wherein each of the two or more casings encloses precisely one of the two or more sub-storages of the storage. In addition, node metadata of at least one of the plurality of nodes of the metadata information or at least edge metadata of at least one of the plurality of the edges of the metadata information are stored on each of the two or more sub-storages, for example.

In accordance with an embodiment, each of the two or more casings, for example, additionally encloses precisely one of the at least two devices.

In one embodiment, for example, edge metadata of one of the plurality of edges of the metadata information are stored in at least one of the two or more sub-storages in an encrypted manner, which include information on a storage location of node metadata of one of the plurality of nodes, wherein these node metadata are stored in another one of the two or more sub-storages in an encrypted manner.

A non-volatile storage is provided additionally. A plurality of nodes and a plurality of edges define a hierarchy of a file system, wherein each edge of the plurality of edges is defined by a predecessor node and a successor node from the plurality of nodes each, wherein each node of the plurality of nodes is associated to either a directory of the file system or a file of the file system. The non-volatile storage includes a plurality of storage cells and a storage interface for accessing the plurality of storage cells, wherein, for each edge of the plurality of edges, edge metadata are stored in the non-volatile storage in an encrypted manner, and wherein, for each node of the plurality of nodes, node metadata are stored in the non-volatile storage in an encrypted manner. The edge metadata of each edge of the plurality of edges include, for at least one node of the plurality of nodes which is the predecessor node or the successor node of this edge, at least one node decryption key for decrypting the node metadata of this node and information on a storage location of the node metadata of this node in the non-volatile storage. The node metadata of each node of the plurality of nodes include, for at least one edge of the plurality of edges for which this node is the predecessor node or the successor node, at least one edge decryption key for decrypting this edge and information on a storage location of the encrypted edge metadata of this edge in the non-volatile storage.

Furthermore, a non-volatile computer-readable medium including a computer program is provided, the computer program, when being executed on a computer, implementing the steps of:
Loading encrypted edge metadata of an edge of a plurality of edges of metadata information from a storage, wherein the metadata information are defined by a plurality of nodes and by a plurality of edges, wherein each edge of the plurality of edges is defined by a predecessor node and a successor node from the plurality of nodes each, wherein each node of the plurality of nodes is associated to either a directory or a file.
Decrypting encrypted edge metadata of the edge of the plurality of edges to obtain decrypted edge metadata of the edge of the plurality of edges, including at least a node decryption key of a node of the plurality of nodes and information on a storage location of encrypted node metadata of the node of the plurality of nodes in the storage, wherein the node of the plurality of nodes is the predecessor node or the successor node of the edge of the plurality of edges.
Loading the encrypted node metadata of the node of the plurality of nodes from the storage using the information on the storage location of the encrypted node metadata of the node of the plurality of nodes. And:
Decrypting the encrypted node metadata of the node of the plurality of nodes using the node decryption key of the node of the plurality of nodes in order to obtain decrypted node metadata of the node of the plurality of nodes.

In addition, a method of accessing metadata information is provided, wherein the metadata information are defined by a plurality of nodes and by a plurality of edges, wherein each edge of the plurality of edges is defined by a predecessor node and a successor node from the plurality of nodes each, wherein each node of the plurality of nodes is associated to either a directory or a file. The method comprises the steps of:
Loading encrypted edge metadata of an edge of the plurality of edges from a storage,
Decrypting encrypted edge metadata of the edge of the plurality of edges to obtain decrypted edge metadata of the edge of the plurality of edges, including at least a node decryption key of a node of the plurality of nodes and information on a storage location of encrypted node metadata of the node of the plurality of nodes in the storage, wherein the node of the plurality of nodes is the predecessor node or the successor node of the edge of the plurality of edges.
Loading the encrypted node metadata of the node of the plurality of nodes from the storage using the information on the storage location of the encrypted node metadata of the node of the plurality of nodes. And:
Decrypting the encrypted node metadata of the node of the plurality of nodes using the node decryption key of the node of the plurality of nodes in order to obtain decrypted node metadata of the node of the plurality of nodes.

### BRIEF DESCRIPTION OF THE DRAWINGS

Embodiments of the invention will be detailed subsequently referring to the appended drawings, in which:

FIG. 1 shows a device for accessing metadata information of a file system in accordance with an embodiment,

FIG. 2 exemplarily shows a file system,

FIG. 3 shows the hierarchy of the file system of FIG. 2, illustrated by nodes and edges,

FIG. 4 illustrates edge metadata and node metadata to the file system of FIG. 2 in accordance with an embodiment,

FIG. 5 shows a device for accessing metadata information of a file system in accordance with another embodiment, further including an output unit,

FIG. 6 shows a system including a device for accessing metadata information and a storage in accordance with an embodiment,

FIG. 7 shows a system in accordance with another embodiment including two devices for accessing metadata information and a storage,

FIG. 8 shows a system in accordance with another embodiment including two devices for accessing metadata information and two sub-storages which are each enclosed by a casing,

FIG. 9 shows a system in accordance with another embodiment, the system including two casings which each enclose a device for accessing metadata information and a sub-storage,

FIG. 10 shows an exemplary distribution of the elements of a file system,

FIG. 11 shows a metadata level and data level with loose coupling,

FIG. 12 shows key and cipher structures with encrypted metadata in the metadata level in accordance with an embodiment, and

FIG. 13 shows an example of a non-volatile storage in accordance with an embodiment.

### DETAILED DESCRIPTION OF THE INVENTION

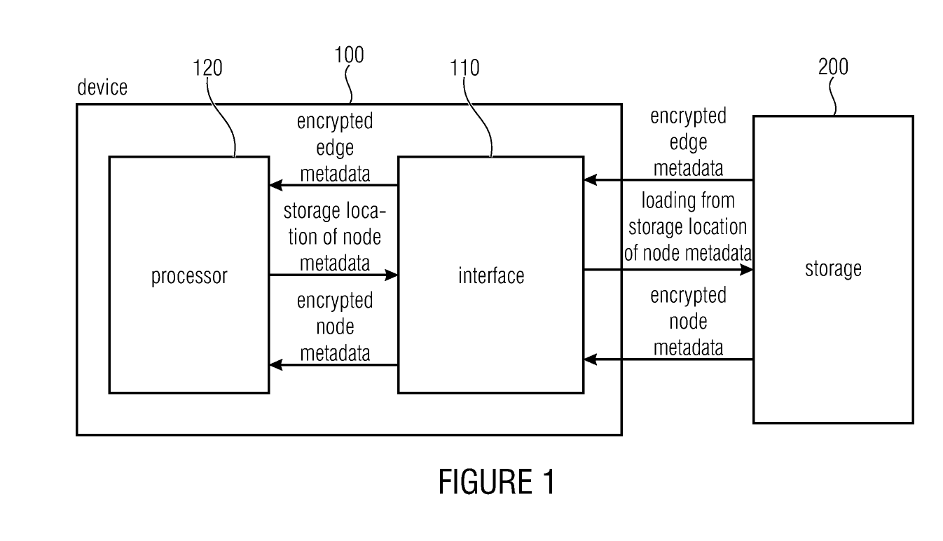

FIG. 1 shows a device 100 for accessing metadata information of a file system in accordance with an embodiment.

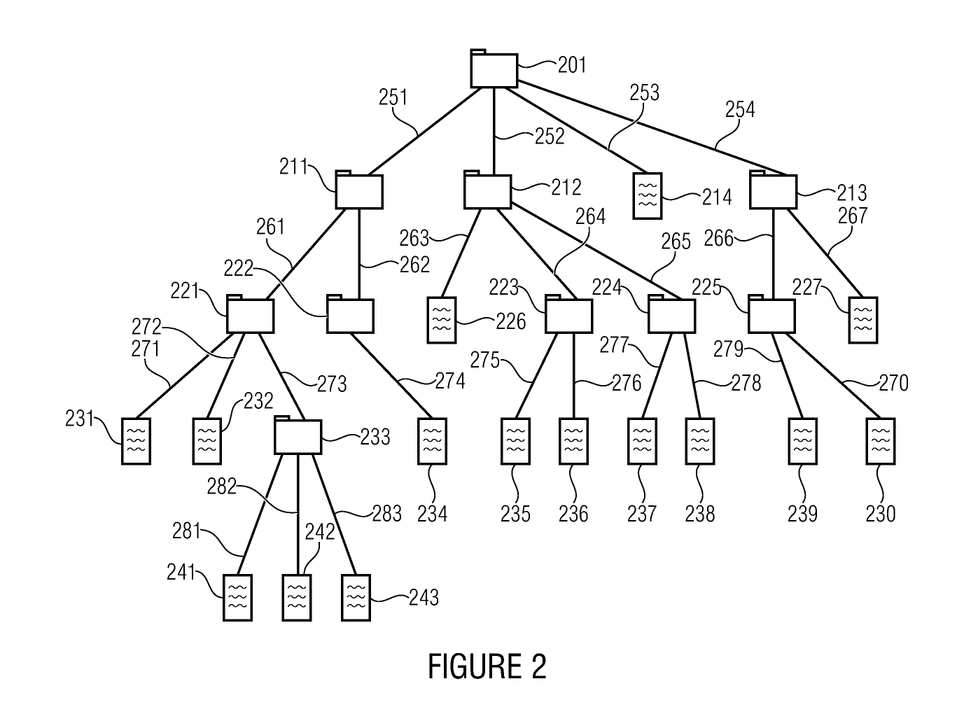

FIG. 2 exemplarily illustrates a file system. The file system comprises directories (directories 201, 211, 212, 213, 221, 222, 223, 224, 225 and 233), files (files 214, 226, 227, 230, 231, 232, 234, 235, 236, 237, 238, 239, 241, 242 and 243) and relations between the directories and between the directories and the files (illustrated by connection lines 251, 252, 253, 254, 261, 262, 263, 264, 265, 266, 267, 270, 271, 272, 273, 274, 275, 276, 277, 278, 279, 281, 282, 283) which define a hierarchy of a file system together with the directories and files. Thus, the directory 201 (exemplarily referred to as root directory) is above the directories 211, 212, 213 and the file 214 of the hierarchy level directly below. The directories 221, 222, 223, 224, 225 and the files 226 and 227, in turn, are located on the hierarchy level directly below, etc. Additionally, it may be seen from the hierarchy of the file system that the directories 221 and 222 are in the directory 211, that the files 231 and 232 and the directory 233 are in the directory 221, etc. The hierarchy of the file system thus results from the arrangement of the directories and the files of the file system among one another, which results from the connection lines between the directories and between the directories and the files.

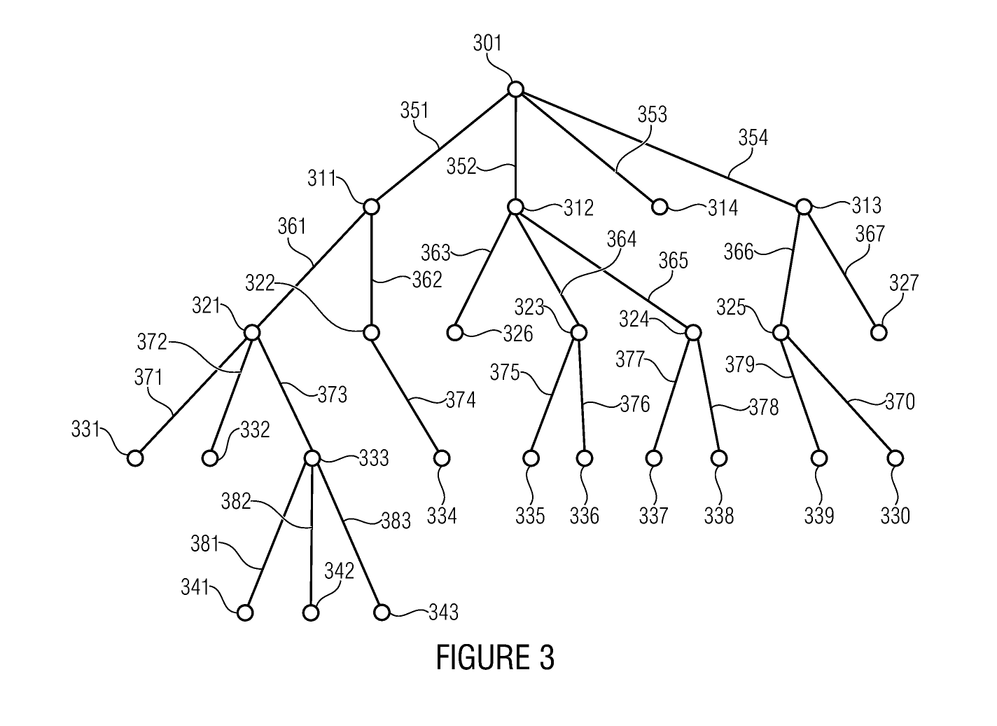

This hierarchy of the file system may be defined by nodes and edges as well. This is exemplarily illustrated by FIG. 3 for the file system of FIG. 2.

In FIG. 3, the edges 351, 352, 353, 354, 361, 362, 363, 364, 365, 366, 367, 370, 371, 372, 373, 374, 375, 376, 377, 378, 379, 381, 382 and 383 shown correspond to the connection lines 251, 252, 253, 254, 261, 262, 263, 264, 265, 266, 267, 270, 271, 272, 273, 274, 275, 276, 277, 278, 279, 281, 282 and 283 of FIG. 2, respectively.

The nodes 301, 311, 312, 313, 321, 322, 323, 324, 325 and 333 correspond to the directories 201, 211, 212, 213, 221, 222, 223, 224, 225 and 233 of FIG. 2, respectively.

In addition, the nodes 314, 326, 327, 330, 331, 332, 334, 335, 336, 337, 338, 339, 341, 342 and 343 correspond to the files 214, 226, 227, 230, 231, 232, 234, 235, 236, 237, 238, 239, 241, 342 and 243 of FIG. 2, respectively.

Instead of defining an edge by a separate reference numeral, an edge could also be defined by the two nodes between which the edge is located. Both nodes in turn correspond to either a directory or a file. In the file system, there is the directory or the file which one of the two nodes is associated to (this node is referred to as successor node of the edge), and in the directory which the other one of the two nodes is associated to (this node is referred to as predecessor node of the edge).

Thus, for example for the edge 361, node 311 is the predecessor node of the edge 361 and node 321 is the successor node of the edge 361. The tuple (311, 321) with the reference numerals of the predecessor node 311 and the successor node 321 of the edge 361 would consequently define the edge 361 as unambiguously as does the reference numeral 361 itself. In this embodiment, the predecessor node 311 is associated to the directory 211 of FIG. 2 and the successor node 321 is associated to the directory 221 of FIG. 2. Correspondingly, the directory 211 of FIG. 2 contains the directory 221 of FIG. 2.

Thus, a plurality of nodes and a plurality of edges define a hierarchy of the file system, wherein each edge of the plurality of edges is defined by a predecessor node and a successor node from the plurality of nodes each, wherein each node of the plurality of nodes is associated to either a directory of the file system or a file of the file system.

The device 100 of FIG. 1 includes an interface 110 and a processor 120. The interface 110 is configured to load encrypted edge metadata of an edge of the plurality of edges from a storage 200.

In embodiments, the storage 200 is, for example, non-volatile.

The processor 120 is configured to decrypt the encrypted edge metadata of the edge of the plurality of edges in order to obtain decrypted edge metadata of the edge of the plurality of edges, which include at least a node decryption key of a node of the plurality of nodes and information on a storage location of encrypted node metadata of the node of the plurality of nodes in the storage 200, wherein the node of the plurality of nodes is the predecessor node or the successor node of the edge of the plurality of edges.

Additionally, the interface 110 is configured to load the encrypted node metadata of the node of the plurality of nodes from the storage 200 using the information on the storage location of the encrypted node metadata of the node of the plurality of nodes.

Furthermore, the processor 120 is configured to decrypt the encrypted node metadata of the node of the plurality of nodes using the node decryption key of the node of the plurality of nodes in order to obtain decrypted node metadata of the node of the plurality of nodes.

The (exemplarily decrypted) node metadata and edge metadata are thus, for example, the metadata information of the file system.

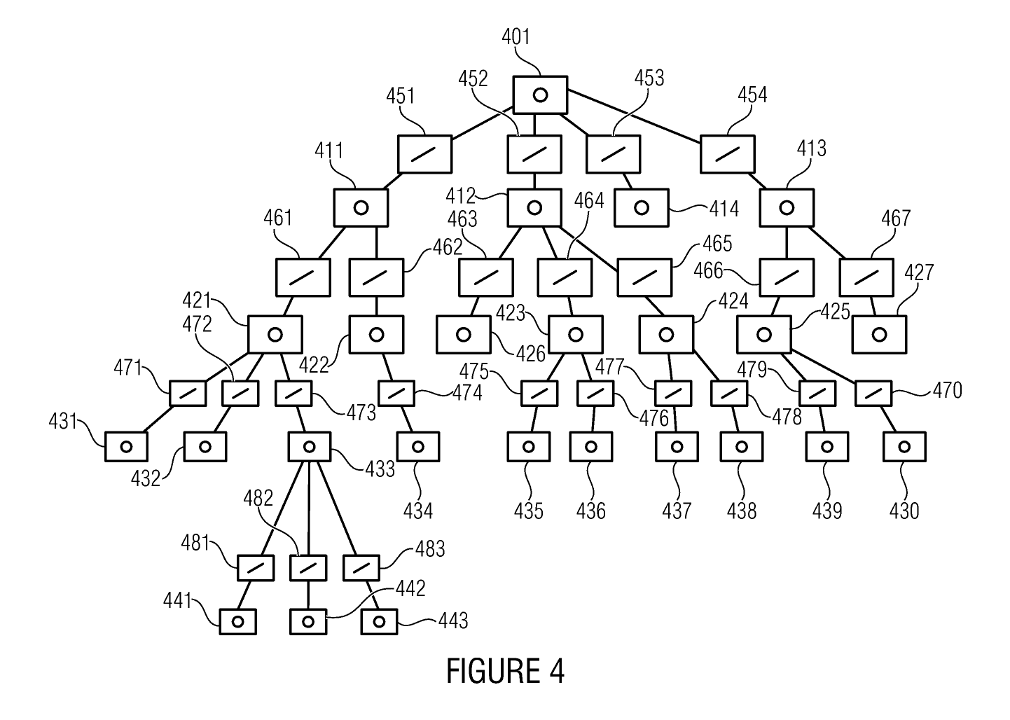

FIG. 4 illustrates the edge metadata and the node metadata which may exemplarily be stored in the storage 200 in an ordered manner.

In FIG. 4, the rectangles containing a bar represent edge metadata and the rectangles containing a circle represent node metadata.

The edge metadata 451, 452, 453, 454, 461, 462, 463, 464, 465, 466, 467, 470, 471, 472, 473, 474, 475, 476, 477, 478, 479, 481, 482 and 483 are the edge metadata of the edges 351, 352, 353, 354, 361, 362, 363, 364, 365, 366, 367, 370, 371, 372, 373, 374, 375, 376, 377, 378, 379, 381, 382 and 383 of FIG. 3, respectively, and thus refer to the connection lines 251, 252, 253, 254, 261, 262, 263, 264, 265, 266, 267, 270, 271, 272, 273, 274, 275, 276, 277, 278, 279, 281, 282 and 283 of FIG. 2, respectively.

The node metadata 401, 411, 412, 413, 421, 422, 423, 424, 425 and 333 here are node metadata of nodes 301, 311, 312, 313, 321, 322, 323, 324, 325 and 333 of FIG. 3, respectively, and each refer to the directories 201, 211, 212, 213, 221, 222, 223, 224, 225 and 233 of FIG. 2, respectively.

In addition, the node metadata 414, 426, 427, 430, 431, 432, 434, 435, 436, 437, 438, 439, 441, 442 and 443 are node metadata of nodes 314, 326, 327, 330, 331, 332, 334, 335, 336, 337, 338, 339, 341, 342 and 343, respectively, and thus refer to the files 214, 226, 227, 230, 231, 232, 234, 235, 236, 237, 238, 239, 241, 342 and 243 of FIG. 2, respectively.

Taking the example of FIGS. 2 to 4, the interface 110 of the device of FIG. 1, for example, is configured to load the encrypted edge metadata 471 of the edge 371 of the plurality of edges from a storage 200.

The processor 120 is configured to decrypt the encrypted edge metadata 471 of edge 371 in order to obtain decrypted edge metadata 471 of the edge 371, which include at least a node decryption key of a node 331 of the plurality of nodes and information on a storage location of encrypted node metadata 431 of the node 331 in the storage 200, the node 331 being the successor node of the edge 371.

In addition, the interface 110 is configured to load the encrypted node metadata 431 of the node 331 from the storage 200 using the information on the storage location of the encrypted node metadata 431 of the node 331.

Additionally, the processor 120 is configured to decrypt the encrypted node metadata 431 of the node 331 using the node decryption key of the node 331 in order to obtain decrypted node metadata 431 of the node 331.

In embodiments, node metadata of a node which refers to a directory exemplarily contain the name of the directory. In embodiments, node metadata of a node which refers to a file exemplarily contain the name of the file.

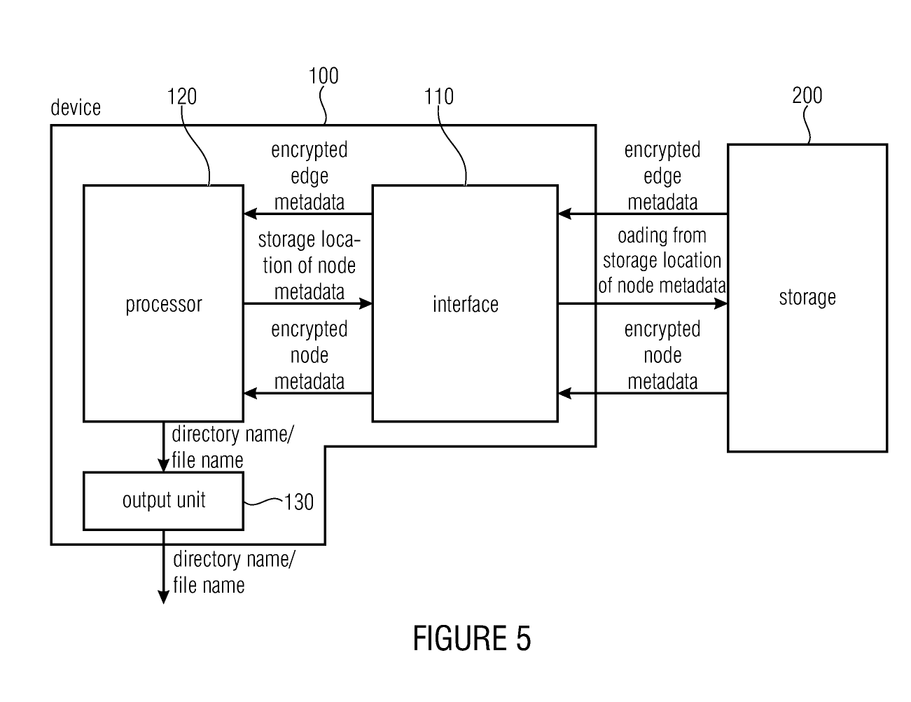

In accordance with embodiments, as illustrated in FIG. 5, the device 100 may exemplarily additionally include an output unit 130 which is a screen unit, a sound output unit or a printer. The decrypted node metadata of the node of the plurality of nodes exemplarily include a directory name of the directory which the node is associated to or, for example, a file name of the file which the node is associated to. The output unit may exemplarily be configured to output the directory name or the file name.

In further embodiments, node metadata of a node which refers to a file exemplarily contain a storage location of the file in the storage.

Thus, in one embodiment, the decrypted node metadata of the node of the plurality of nodes may exemplarily include information on a storage location of the file which the node is associated to. The interface 110 is, for example, configured to load the file which the node of the plurality of nodes is associated to from the storage 200 using the information on the storage location on the file which the node of the plurality of nodes is associated to. The processor 120 is, for example, configured to output the file which the node of the plurality of nodes is associated to.

In embodiments, the edge metadata of each of the edges exemplarily contain information on the storage location of the successor node of this edge. This allows stepping down to the next-lower node in the hierarchy.

In further embodiments, the edge metadata of each of the edges exemplarily also contain information on the storage location of the predecessor node of this edge. This allows stepping down to the next-lower node in the hierarchy.

Some embodiments dispense with storing information on the predecessor node in the edge metadata of each of the edges. Instead, it may be agreed upon that, when stepping through the file system, the highest node (the root node) in the hierarchy of the file system is started with and that the edge and node metadata of predecessor nodes or at least the information on the storage locations of the edge and node metadata of predecessor nodes are kept stored in a buffer (not shown) of the device 100 so that this information will still be available when stepping up from a lower node.

In embodiments, the node metadata of each of the nodes exemplarily also contain information on the storage location of all the edges for which this node is a predecessor node. This allows stepping down to the next-lower edges in the hierarchy.

In further embodiments, the node metadata of each of the nodes exemplarily also contain information on the storage location of all the edges for which this node is a successor node.

Some embodiments dispense with including, in the node metadata of each of the nodes, information on the storage location of all the edges for which this node is a successor node. Instead, it may be agreed upon that, when stepping through the file system, the highest node (the root node) in the hierarchy of the file system is started with and that the edge and node metadata of predecessor nodes or at least the information on the storage locations of the edge and node metadata of predecessor nodes are kept stored in a buffer (not shown) of the device 100 so that this information will still be available when stepping from a lower node. Such embodiments are particularly useful when each node of the file system is a successor node or one edge only, i.e. in the case of a regular tree structure of the file system, like in FIG. 2. However, when two higher edges in the file system hierarchy lead to the same node, it may be particularly useful to include, into the node metadata of this node, information on the storage location of all the edges for which this node is a successor node.

In alternative embodiments, the node metadata of each of the nodes include only information on the storage location of edge metadata of one edge at most for which this node is a predecessor node. If the node really has more than one edge for which this node is a predecessor node, in some embodiments, the storage location of edge metadata of another edge for which this node is the predecessor node may be indicated in the edge metadata of the edge. In the edge metadata of this further edge, in turn, the storage location of the edge metadata of a third edge for which this node is the predecessor node may be indicated. This procedure will be continued until the storage locations of the edge metadata of all the edges for which this node is a predecessor node have been specified.

Embodiments may also provide for the node metadata of each of the nodes to include only information on the storage location of edge metadata of at most one edge for which this node is a successor node. If the node really has more than one edge for which this node is the successor node, in such embodiments, the storage location of edge metadata of another edge for which this node is the successor node may be indicated in the edge metadata of the edge. The storage location of the edge metadata of a third edge for which this node is the successor node in turn may be indicated in the edge metadata of this further edge. This procedure will be continued until the storage locations of the edge metadata of all the edges for which this node is a successor node have been specified.

In embodiments, the edge metadata of several or all edges of the plurality of edges and the node metadata of several or all nodes of the plurality of nodes are stored in the storage 200 in an encrypted manner.

In embodiments, the encryption keys for encrypting are different for two or for more or for all edge metadata and node metadata.

Thus, in embodiments, the edge metadata of several or each of the edges contain a node decryption key for decrypting the metadata of the node which is a successor node of this edge.

In some embodiments, the edge metadata of several or each of the edges also contain a node decryption key for decrypting the metadata of the node which is the predecessor node of this edge.

In embodiments, the node metadata of several or each of the nodes contain an edge decryption key for each of the edges for which this node is a predecessor node in order to decrypt the respective edge.

In alternative embodiments, the edge metadata of each of the nodes contains, at most, one edge decryption key for, at most, one of the edges for which this node is a predecessor node. When there are, for this node, one or more further edges for which this node is a predecessor node, the edge metadata of that edge for which the edge decryption key has been provided in the node metadata of this node will contain another edge decryption key for the edge metadata of another one of the one or more further edges for which this node is a predecessor node. This procedure will be continued until the edge encryption keys for the edge metadata of all the edges for which this node is a predecessor node have been specified.

Correspondingly, in embodiments, the node metadata of several or each of the nodes may contain an edge decryption key for each of the edges for which this node is a successor node in order to decrypt the respective edge.

In alternative embodiments, the edge metadata of each of the nodes contain at most one edge decryption key for at most one of the edges for which this node is a successor node. If there are, for this node, one or more further edges for which this node is a successor node, the edge metadata of that edge for which the edge decryption key has been provided in the node metadata of this node will contain another edge decryption key for the edge metadata of another one of the one or more further edges for which this node is a successor node. This procedure will be continued until the edge encryption keys for the edge metadata of all the edges for which this node is a successor node have been specified.

By encrypting the edge and node metadata, an attacker accessing the storage in an unauthorized manner will be prevented from getting access to the metadata information of the file system.

In order for a user to be able to use the metadata of the edges and nodes of the file system, it is, for example, only necessitated for the user to have access to one of the nodes or one of the edges of the file system, exemplarily when he knows the node or edge decryption key of one of the nodes or one of the edges and the information on the storage location thereof in the storage. The user may then gather from the metadata of such a node the storage location of edge metadata of edges and the decryption keys of edges for which this node is a predecessor node or successor node. Additionally, the user may gather from the metadata of a corresponding edge the storage location of node metadata of nodes and the decryption keys of nodes being a predecessor node or successor node of such an edge. The access to further metadata for the authorized user results from the metadata which may be determined in this way.

In a special embodiment, all authorized users exemplarily are in possession of the decryption key for the top most node in the file system hierarchy (in FIG. 3 root node 301, for example) and have the information on its storage location in the storage 200.

In a special embodiment, each of the authorized users is, for example, in possession of the decryption key for a specific user node which is connected to the top most node in the file system hierarchy (root node 301 in FIG. 3, for example) via an edge and has the information on its storage location in the storage 200.

The directory 211 may, for example, be a directory of a first authorized user, wherein this user may be permanently in possession of the decryption key of the corresponding node 311 and the storage location of the node metadata 411 of the corresponding node 311. In addition, the directory 212 may exemplarily be a directory of a first authorized user, wherein this user may be permanently in possession of the decryption key of the corresponding node 312 and the storage location of the node metadata 412 of the corresponding node 312.

Specific user directories of this kind may, in different embodiments, also be located at any other position in the file system hierarchy.

In addition, in further embodiments, the decryption key of any node and the information on the storage location of the node metadata of this any node may be communicated to the authorized user by a managing unit (not shown) of the file system when first operating with the file system, when the user has been authenticated by means of a log-in procedure, either when starting the device or at a later time.

Storing several or all of the node and edge metadata with individual keys is of advantage. A smaller quantity of data having been encrypted using the same key is available for an attacker. Thus, determining regularities of the ciphered data so as to draw conclusions as to the key use becomes considerably more difficult.

In addition, it is not necessary for one key in the entire system to be known to each user. Rather, the key is exchanged only between neighboring nodes, i.e. the decryption key of one node is stored in the edge metadata of neighboring edges of the file system, but does not have to be distributed over the entire system. When distributing a single system key over the entire system, this would offer additional points of attack for an attacker.

Discussing a special embodiment, the above example having been discussed referring to FIGS. 2-4 and its edge 371 and node 331 is continued below:

In accordance with this embodiment, the device 100 is, for example, configured to obtain the decrypted edge metadata 471 of the edge 371 by the processor 120 being configured to decrypt further encrypted node metadata 421 of another node 321 in order to obtain further decrypted node metadata 421, wherein the further node 321 is the predecessor node or the edge 371, wherein the further decrypted metadata 421 include at least an edge decryption key of the edge 371 and information on a storage location of the encrypted edge metadata 471 of the edge 371 of the plurality of edges in the storage 200.

In this case, the interface 110 is, for example, configured to load the encrypted edge metadata 471 of the edge 371 of the plurality of edges from the storage 200 using the information on the storage location of the encrypted edge metadata 471 of the edge 371.

The processor 120 is, for example, configured to decrypt the encrypted edge metadata 471 of the edge 371 using the edge decryption key of the edge 371 in order to obtain the decrypted edge metadata 471 of the edge 371.

The device 100 configured in accordance with this embodiment thus exemplarily determines the node metadata 431 of the node 331 by at first reading out and decrypting the edge metadata 471 of the edge 371, wherein these edge metadata 471 in turn have been determined by decrypting and then using the node metadata 421 of the node 321.

A device 100 configured in this way thus determines and uses both an edge decryption key of the edge 371 having been used in the encrypted node metadata 421 of the node 321, and a node decryption key of the node 331 having been present in the decrypted edge metadata 471 of the edge 371. This means that a stepwise usage of different, hidden decryption keys is supported.

In one embodiment, the interface 110 is, for example, configured to load an authorization key k_{D}^{U(v)} for the edge of the plurality of edges, when a user is authorized to access the successor node of the edge of the plurality of edges, or the interface 110 is, for example, configured to load an authorization key k_{D}^{U(v)} for the edge of the plurality of edges when the user is authorized to access the predecessor node of the edge of the plurality of edges. The processor 120 is, for example, configured to decrypt the encrypted edge metadata using the edge decryption key and the authorization key k_{D}^{U(v)} of the edge of the plurality of edges in order to obtain the decrypted edge metadata of the edge of the plurality of edges.

In some embodiments, for example, for one, for more or for all nodes, only certain users are to be authorized to access a certain node. In this case, it may be provided for metadata of an edge for which the node is the successor node, or the metadata of an edge for which the node is the predecessor node to be encrypted additionally using another key and that additionally an authorization key k_{D}^{U(v)} is necessitated for decrypting same.

In some embodiments, this may exemplarily be realized by a user environment knowing, from each user authorized to access a node, where in a storage the authorization key k_{D}^{U(v)} for an edge which has this node as a successor or predecessor node is stored.

When, however, the user does not have an access authorization for a node, the user does not know the storage position of the authorization key k_{D}^{U(v)} for the edges having this node as a predecessor node or successor node either.

Correspondingly, in accordance with an embodiment, the interface 110 is, for example, configured not to load an authorization key k_{D}^{U(v)} for the edge of the plurality of edges when the user is not authorized to access the successor node of the edge of the plurality of edges, or the interface 110 is, for example, configured not to load an authorization key k_{D}^{U(v)} for the edge of the plurality of edges when a user is not authorized to access the predecessor node of the edge of the plurality of edges. The processor 120 is, for example, configured not to decrypt the encrypted edge metadata of the edge of the plurality of edges when the user is not authorized to access the successor node of the edge of the plurality of edges, or the processor 120 is, for example, configured not to decrypt the encrypted edge metadata of the edge of the plurality of edges when the user is not authorized to access the predecessor node of the edge of the plurality of edges.

It is possible to encrypt the metadata of the edges such that, for decrypting, at first the edge decryption key and then the authorization key k_{D}^{U(v)} are to be used. Alternatively, the metadata of the edges may also be encrypted such that, for decrypting, at first the authorization key k_{D}^{U(v)} and then the edge decryption key are to be used.

In one embodiment, the processor 120 is, for example, configured to decrypt the encrypted edge metadata of the edge of the plurality of edges by the processor 120 decrypting the encrypted edge metadata using the edge decryption key of the edge of the plurality of edges in order to obtain first encrypted intermediate data of the edge of the plurality of edges, and by the processor 120 decrypting the first encrypted intermediate data using the authorization key of the edge of the plurality of edges in order to obtain the decrypted edge metadata of the edge of the plurality of edges.

In accordance with an embodiment, the processor 120 is, for example, configured to decrypt the encrypted edge metadata of the edge of the plurality of edges by the processor 120 decrypting the encrypted edge metadata using the authorization key of the edge of the plurality of edges in order to obtain second encrypted intermediate data of the edge of the plurality of edges, and by the processor 120 decrypting the second encrypted intermediate data using the edge decryption key of the edge of the plurality of edges in order to obtain the decrypted edge metadata of the edge of the plurality of edges.

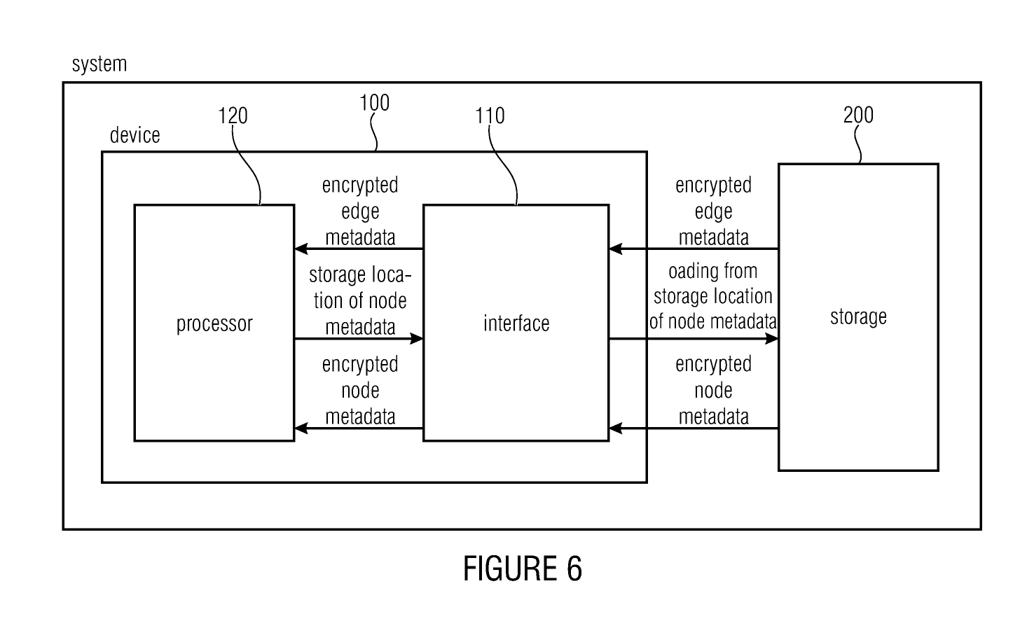

FIG. 6 shows a system realizing access to metadata information of a file system.

A plurality of nodes and a plurality of edges define a hierarchy of the file system, wherein each edge of the plurality of edges is defined by a predecessor node and a successor node from the plurality of nodes each, wherein each node of the plurality of nodes is associated to either a directory of the file system or a file of the file system.

The system includes one or more of the devices 100 described above and a storage 200.

The interface 110 of each of one or more devices 100 is configured to load encrypted edge metadata of an edge of the plurality of edges of metadata information from the storage 200.

The processor 120 of each of the one or more devices 100 is configured to decrypt the encrypted edge metadata of the edge of the plurality of edges in order to obtain decrypted edge metadata of the edge of the plurality of edges, including at least a node decryption key of a node of the plurality of nodes and information on the storage location of encrypted node metadata of the node of the plurality of nodes in the storage 200, wherein the node of the plurality of nodes is the predecessor node or the successor node of the edge of the plurality of edges.

In addition, the interface 110 of each of the one of several devices 100 is configured to load the encrypted node metadata of the node of the plurality of nodes using the information on the storage location of the encrypted node metadata of the node of the plurality of nodes from the storage 200.

Furthermore, the processor 120 of each of the one or more devices 100 is configured to decrypt the encrypted node metadata of the node of the plurality of nodes using the node decryption key of the node of the plurality of nodes in order to obtain decrypted node metadata of the node of the plurality of nodes.

In accordance with an embodiment, the system particularly includes two or more of the devices 100, 101 described above, for example.

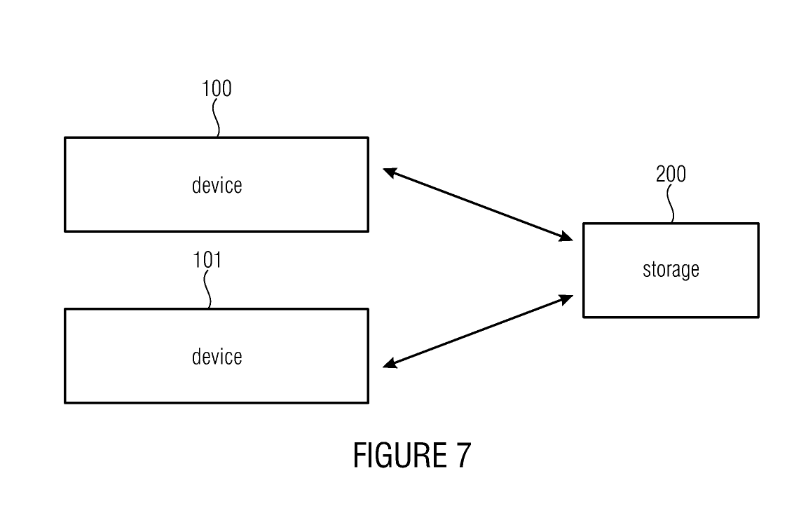

FIG. 7 shows a system 100, 101 comprising two or more devices described before and a storage 200.

In one embodiment, the storage 200 includes two or more sub-storages 201, 202, for example. In addition, the system exemplarily comprises two or more casings 701, 702, wherein each of the two or more casings encloses precisely one of the two or more sub-storages 201, 202 of the storage 200. Additionally, at least node metadata of at least one of the plurality of nodes of the metadata information or at least edge metadata of at least one of the plurality of edges of the metadata information are stored, for example, on each of the two or more sub-storages 201, 202.

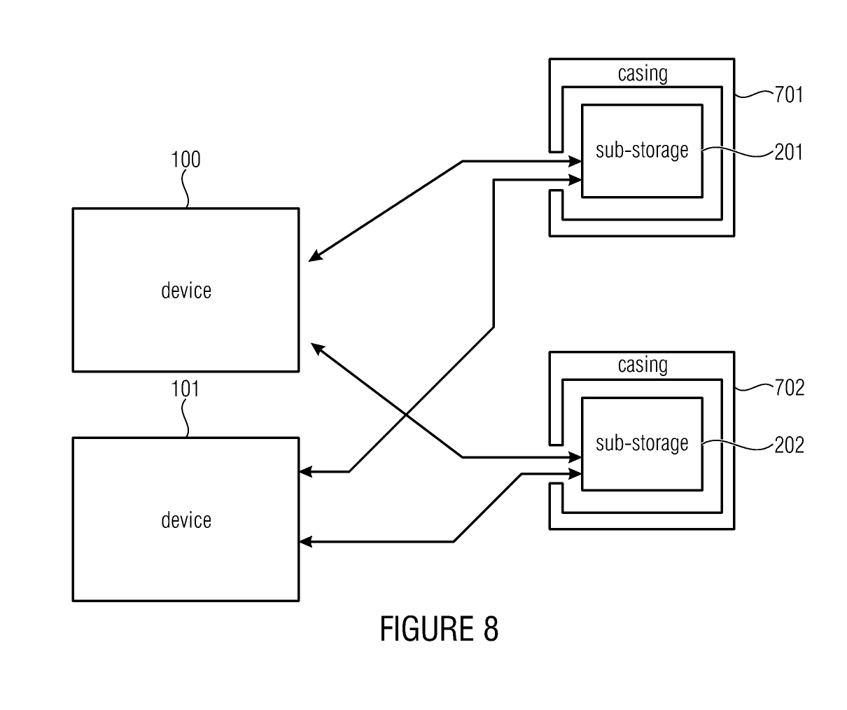

FIG. 8 shows such a system comprising two of the devices 100, 101 described before, a first casing 701 encasing a first sub-storage 201 of the storage 200, and a second casing 702 enclosing a second sub-storage 202 of the storage 200.

The concepts provided in the embodiments are of particular advantage for distributed systems.

Thus, the edge and node metadata may be decrypted, for example, using edge and node decryption keys, wherein the decryption keys have to be stored only in neighboring node or neighboring edge metadata. The keys, in contrast, do not have to be distributed over the entire file system.

In addition, the storage location of edge metadata or node metadata of neighboring edges and neighboring nodes, respectively, is, for example, stored in the node metadata and the edge metadata. This storage location may be located in a different sub-storage than that where the metadata being considered at present are located.

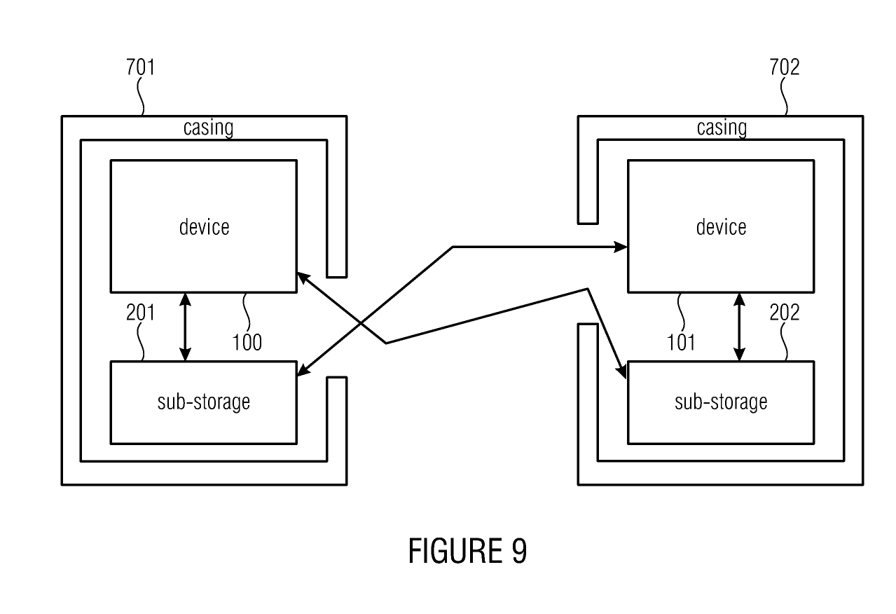

In accordance with a special embodiment which is illustrated in FIG. 9, each of the two or more casings 701, 702, for example, additionally encloses precisely one of the at least two devices 100, 101.

The device 100, the sub-storage 201 and the casing 701 may be part of a personal computer. The device 101, the sub-storage 202 and the casing 702 may be part of another personal computer.

In one embodiment, edge metadata of one of the plurality of edges of the metadata information are stored, for example, in at least one of the two or more sub-storages 201, 202 in an encrypted manner, comprising information on a storage location of node metadata of one of the plurality of nodes, wherein these node metadata are stored in another one of the two or more sub-storages in an encrypted manner.

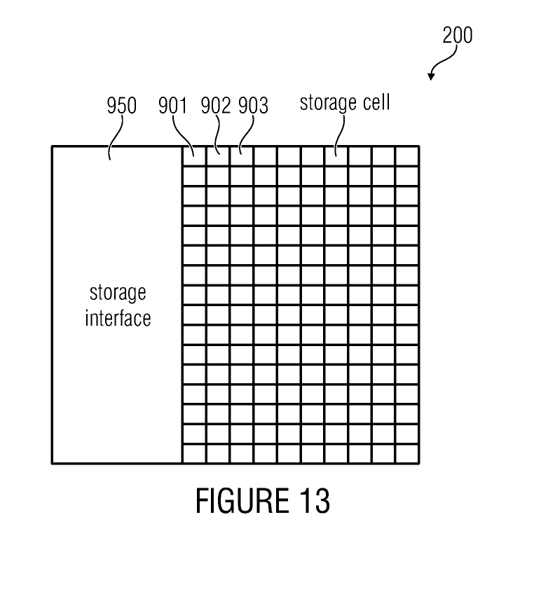

FIG. 13 shows an example of the storage 200 which in a special embodiment of FIG. 13 is a non-volatile storage.

A plurality of nodes and a plurality of edges define a hierarchy of a file system, wherein each edge of the plurality of edges is defined by a predecessor node and a successor node from the plurality of nodes each, wherein each node of the plurality of nodes is associated to either a directory of the file system or a file of the file system.

The storage 200 of the embodiment in FIG. 13 includes a plurality of storage cells 901, 902, 903 and a storage interface 950 for accessing the plurality of storage cells 901, 902, 903.

Edge metadata are stored in the non-volatile storage 200 in an encrypted manner for each edge of the plurality of edges.

Node metadata are stored in the non-volatile storage 200 in an encrypted manner for each node of the plurality of nodes.

The edge metadata of each edge of the plurality of edges include, for at least one node of the plurality of nodes which is the predecessor node or successor node of this edge, at least one node decryption key for decrypting the node metadata of this node and information on a storage location of the node metadata of this node in the storage 200.

The node metadata of each node of the plurality of nodes include, for at least one edge of the plurality of edges for which this node is the predecessor node or the successor node, at least one edge decryption key for decrypting this edge and information on a storage location of the encrypted edge metadata of this edge in the non-volatile storage 200.

Special embodiments and background information of special embodiments will be discussed below in greater detail.

Embodiments allow setting up a distributed file system fulfilling the security requirements of mobile peripherals. Thus, the concept allows combining any storage services, irrespective of the sphere of influence of the installing party, by separating the directory structure from the actual data and, thus, also from the storage location thereof. In addition, each individual element is protected by individual encryption and arbitrarily individual access rights. This is achieved by means of a special key/cipher structure. An element here may be a directory, a file or any grouping of these data sets.

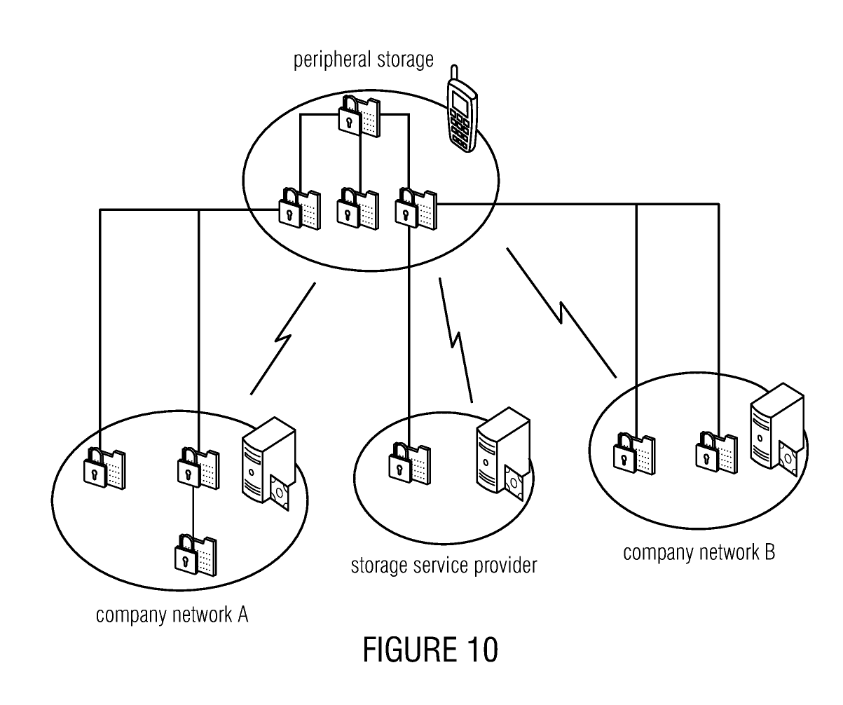

FIG. 10 shows an exemplary distribution of the elements of a file system. However, each of these storage services is possible, but dispensable. It does, for example, not make any sense to store data of the file system on the peripheral, since these may not be reached when starting from a different apparatus.

All the metadata of an element are additionally protected by encryption. Thus, the entire structure of the directory system is hidden from the eyes of unauthorized parties. Positional information of the individual data may be gathered from the protected metadata, but cannot be seen by unauthorized parties either.

The security of the cryptographic system is guaranteed by using a trusted environment. However, such an environment is not known to be compatible with distributed systems available at present. This is, however, ensured by the key/cipher structure mentioned.

As has been mentioned before, such an environment is, for example, made available by external hardware which is connected to the respective peripheral making use of the file system via a secure channel. Cryptographic operations related to the file system will be executed exclusively within this environment. In particular, the keys for these operations are available only in the trusted environment. An environment realized in hardware may, for example, be provided by CyphWay, which some embodiments, for example, are completely compatible with.

In one embodiment, a trusted environment is realized by a virtual machine the cryptographic operations of which are based on homomorphous cryptography.

Embodiments allow setting up distributed storages which use any storage services, thus functioning as a file system and additionally offering higher security than crypto containers.

In embodiments, a setup of a distributed directory system or crypto container is realized without being dependent on the underlying storage services.

In accordance with embodiments, ensuring confidentiality of data and file structure with additionally hiding directories and files accessing which a user is not authorized is achieved.

In addition, in embodiments, protecting the cryptographic system is achieved by using a secure zone. The cryptographic system here is also protected from the file system client.

In accordance with embodiments, a cipher structure is used in which the metadata and the actual data are encrypted separately and the directory system may be navigated through by means of the metadata.

In embodiments, a trusted environment for the cryptographic operations of a distributed directory system or crypto container which is cut off virtually or physically from the actual client is used. It is decisive here for the keys used never to leave this trusted environment in an unencrypted manner.

Embodiments may be employed in particular in company and authority, and in a private environment. Wherever different storage services are combined and the security of data and structural information must not or should not be neglected, the invention offers a robust and, particularly, secure solution. Specifically, distributed crypto containers or distributed file systems may be set up which guarantee a higher degree of security than available solutions are able to provide for homogenous non-distributed systems.

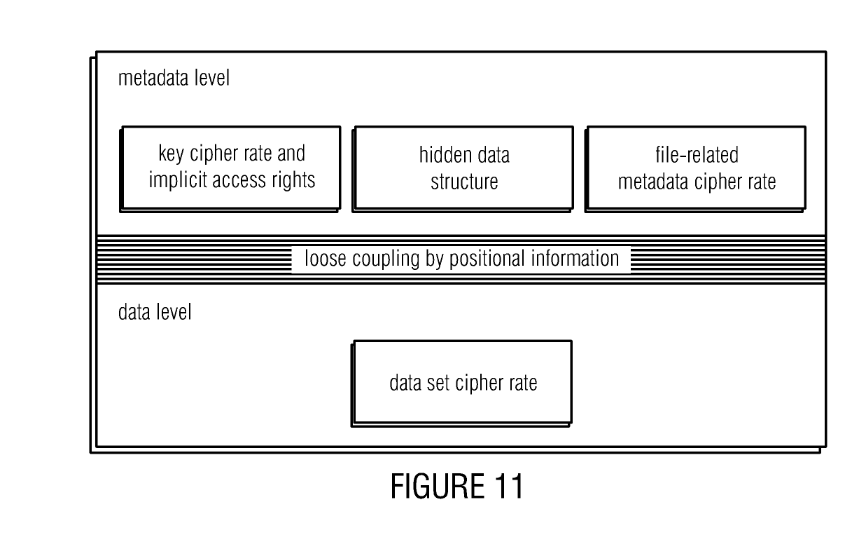

In accordance with embodiments, separation of the metadata from the underlying data and the dependency of the metadata is realized and, thus, of the metadata information from a special key/cipher structure. The result is a metadata level (see FIG. 11) which is dealt with separately from the data level.

FIG. 11 shows a metadata level and a data level with loose coupling. Any structure in the metadata level here is independent on the data set ciphers and, thus, the storage location thereof. The structure of the data is transferred to the metadata level and, thus, is under its access control.

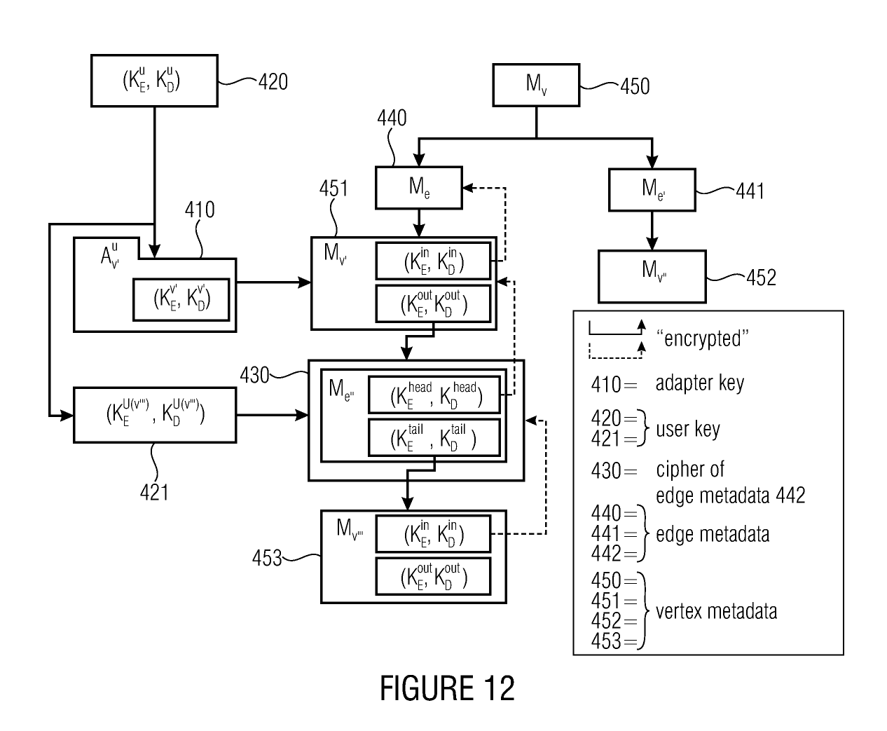

FIG. 12 illustrates the structure as a key/cipher structure. In particular, FIG. 12 shows a key and cipher structure having encrypted metadata in the metadata level.

In FIG. 12, reference numerals 420, 421 refer to user keys, reference number 410 to an adapter key, reference numbers 440, 441 442 to edge metadata, reference number 430 to a cipher of edge metadata 442, and reference numerals 450, 451, 452, 453 to node metadata.

The metadata level and, in particular, the structure of the metadata level will be described below.

For abstraction purposes, grouping of elements is omitted when discussing the structure. The keys are only available in an unencrypted manner within the trusted environment. Outside, they are stored in the form of ciphers (see, for example, A. Jakoby, W. Müller und H. Vagts: Protecting Sensitive Law Enforcement Agencies Data—Data Security in the Cloud [Konferenz]//9th International Conference on Cyber Warfare and Security ICCWS-2014—West Lafayette, Ind., USA, 2014; and F. Patzer: Konzeptionierung und Validierung eines Schlüsselmanagements für den Demonstrator “CyphWay”.—Karlsruhe, Germany: Fraunhofer Institut für Optronik, Systemtechnik und Bildauswertung, September 2014).

What follows are some definitions:

A file system may be represented as a graph G=(V,E), wherein a node corresponds to a directory or a file. An edge stands for a relation of membership. When (u,v) is an edge from E, u is a directory and vεV is either a sub-directory or a file contained in uεV. As has been discussed, these may also be groupings of elements, which from here on, however, will no longer be mentioned specifically.

Bijective mapping i:V∪E→N and the partial mappings σ:N→M_{V} and ρ:N→M_{E} will be defined, N representing the quantity of indices, M_{V} the quantity of node metadata and M_{E} the quantity of edge metadata. Indices here are identifiers of the graph elements.

Additionally, mappings for accessing the distributed data sets will be defined. The mapping τ:N→S maps an index nεN to a storage location sεS, S representing the quantity of all the storage locations possible. In order to map the storage location to a graph element and its metadata, the mapping φ:S→(V×M_{V})∪(E×M_{E}) is defined. Thus, the storage location of the graph element φ(τ(n)) can be determined using τ(n). This applies for all elements from V∪E.

Furthermore, Γ⁻(v) is defined to be the quantity of all the edges with a starting node v, and Γ⁺(v) to be the quantity of all the edges with the final node v. It is assumed that, for each node v, there is a specific order of Γ⁻(v) and Γ⁺(v), since G is an abstraction of a file system or a structured container. This requirement may of course also be bypassed by additionally integrated information.

In order to be able to navigate within the graph, definitions of in(x) and out(x) follow, wherein the following applies for u, v, wεV; e₁, e₂εE; e₁=(u,v); e₂=(v,w);

in(v) is the first edge from Γ⁺(v) and in(e₁) is the direct successor of e₁ in Γ⁺(v).

out(v) is the first edge from Γ⁻(v) and out(e₂) is the direct successor of e₂ in Γ⁻(v).

For encryption, E is defined to be an encryption algorithm and D to be a decryption algorithm such that the correctness m=D(k_{D}, E(k_{E}, m)) applies for each key pair (k_{E},k_{D}) and each plain text m.

Let kE be a key for encrypting; wherein E exemplarily defines encryption in the following format: E(encryption key, data to be encrypted); and wherein kD exemplarily is a (corresponding) key for encrypting; wherein D exemplarily defines decryption in the following format: D(decryption key, encrypted data).

In accordance with an embodiment, the encryption strategy may be as follows:

The metadata of each node and each edge are encrypted using an individual key.

Additionally, the metadata of each node v contain keys necessitated for decrypting the metadata of the incident edges from Γ⁺ and Γ⁻.

Furthermore, the metadata of each edge contain keys necessitated for decrypting the metadata of the nodes connected thereto.

The metadata of each edge are encrypted again. This second encryption takes place using an access rights key ensuring that only users having access rights to the final node may obtain information thereon.

The metadata Mv of a node v exemplarily include the names of the directory represented or the file represented.

Additionally, the metadata Mv of the node v exemplarily include values in(v), i(in(v)), τ(i(in(v))) and out(v), i(out(v)), τ(i(out(v))).

Furthermore, the metadata Mv of the node v exemplarily include a key pair (k_{E}^{in(v)}, k_{D}^{in(v)}) for encrypting/decrypting the metadata in Γ⁺(v) and a key pair (k_{E}^{out}, k_{D}^{out}) for encrypting/decrypting the metadata in Γ⁻(v).

The metadata Me of an edge e=(u,v) thus exemplarily include the names of the directories or files which are represented by u and v.

Furthermore, the metadata Me of the edge e exemplarily include values i(u), τ(i(u)) and i(v), τ(i(v)).

In addition, the metadata Me of the edge e exemplarily include the values in(e), i(in(e)), Σ(i(in(e))) and out(e), i(out(e)), τ(i(out(e))).

Furthermore, the metadata Me of the edge e exemplarily include a key pair (k_{E}^{head}, k_{D}^{head}) for encrypting/decrypting the metadata of u and a key pair (k_{E}^{tail}, k_{D}^{tail}) for encrypting/decrypting the metadata of v.

Metadata are stored as a cipher. As already mentioned, the metadata of the edges are encrypted again. For an edge with the final node v, consequently a key pair (k_{E}^{U(v)}, k_{D}^{U(v)}) is necessitated the function of which will be discussed in greater detail below.

The elements of a file system forming in this way may be represented as follows:

(i(v), E(k_{E}^{v},Mᵥ)) for each node vεV, wherein (k_{E}^{v}, k_{D}^{v}) is the key pair associated to v.

(i(e), E(k_{E}^{e},in(e)), E(k_{E}^{e},out(e)), E(k_{E}^{e},E(k_{E}^{U(v)}, Mₑ))) for each edge eεE, wherein (k_{E}^{e}, k_{D}^{e}) is the key pair associated to e and e has the final node v.

If out(v) equals the edge e, additionally the following applies: (k_{E}^{e}, k_{D}^{e})=(k_{E}^{out}, k_{D}^{out})εMᵥ.

Accessing a directory which is mapped by the node v is to be presented exemplarily. The contents of the directory here is determined in correspondence with the respective rights. Some embodiments are implemented in accordance with the following pseudo code, for example:

```
determineDirectoryContent(v)
begin
  determine Mᵥ by decrypting E(k_{E}^{v}, Mᵥ)
  determine e = out(v) and k_{D}^{e} = k_{D}^{out}
  repeat
    let t = (i(e), E(k_{E}^{e}, in(e)), E(k_{E}^{e}, out(e)), E(k_{E}^{e}, E(k_{E}^{U(v)}, Mₑ)))
    determine E(k_{E}^{e}, Mₑ) by decrypting E(k_{E}^{e}, E(k_{E}^{U(v)}, Mₑ)) from t
    if the user has access to k_{D}^{U(v)} then
      decrypt E(k_{E}^{U(v)}, Mₑ)
      add the necessary content information from Mₑ to the
      content of v
    decrypt E(k_{E}, out(e))
    let e = out(e)
  until e is defined
end
```

Accessing the parent directory here takes place in analogy by replacing out by in and limiting the iterations if not all the parent elements are to be determined. It is to be mentioned here that only metadata are to be operated on. The actual underlying data sets may be reloaded when needed.

Up to now, discussion of acess control has been put aside, which will be done now. As can be seen in FIG. 12, a user key (k_{E}^{u}, k_{D}^{u}) is used in order to generate an adapter cipher Aᵥ^{u}. This cipher contains, for each node v which the user u is allowed to access, the key (k_{E}^{v}, k_{D}^{v}) and the storage location τ(i(v)). It is assumed here that the trusted environment of the user knows (k_{E}^{u}, k_{D}^{u}) and thus is able to decrypt (k_{E}^{u}, Aᵥ^{u}).

If the metadata Me of a node e, the starting node of which is v, were encrypted only using the key k_{E}^{out}, the user u would be able to see and decrypt all the sub-directories and files of v, when the cipher (k_{E}^{u}, Aᵥ^{u}) is present. For this reason, embodiments provide for the adapter key (k_{E}^{U(v)}, k_{D}^{U(v)}) which is encrypted by k_{E}^{u} (for each user u which is intended to access the “contents” of v).

Access rights may exemplarily be realized as follows:

In order to realize access rights of an individual user, the following two scenarios may, for example, be differentiated between:
The user has access to a directory and his access rights to sub-directories or files within this directory or to higher directories are to be checked (first scenario), or
This is about the first access to a directory or a file within the file system, exemplarily about the first access of a user to an element within the file system (second scenario).

In order to check the access rights in the first scenario, access keys (k_{E}^{e}, k_{D}^{e}) have been introduced.

In order to control first access in the second scenario, what is suggested in A. Jakoby, W. Müller and H. Vagts: Protecting Sensitive Law Enforcement Agencies Data—Data Security in the Cloud [Konferenz]//9th International Conference on Cyber Warfare and Security ICCWS-2014—West Lafayette, Ind., USA, 2014, is done, for example.

As illustrated in FIG. 12, a user key pair 420 (k_{E}^{u}, k_{D}^{u}) is introduced for each user. It is assumed that this user key pair 420 is stored at the user so that no unauthorized attacker may get access to the user key pair 420. In order to check access rights, in some embodiments, it may be provided for an administrator within an organization to have access to these keys.

If a user has access to a node v within the file system structure, the key (k_{E}^{v}, k_{D}^{v}) is used to store the metadata set My (the node metadata) of this node, and the corresponding storage location in an encrypted form, in an encrypted manner with the key k_{E}^{u} in the distributed storage. This kind of information is referred to as adapter data or adapter key Aᵥ^{u} 410, and it is assumed that each user knows the storage location where his user-specific information E(k_{E}^{u}, Aᵥ^{u}) for all nodes v which this user has access to are stored.

When a user wants to have first access to a directory or a file, represented by a node v, the user reads out, for example, the corresponding encrypted adapter data E(k_{E}^{u}, Aᵥ^{u}). After having decrypted this information, he may access the metadata set Mv.

In order to extend the access rights of a user, the correspondingly encrypted adapter data for this user may simply be added to the system. In analogy, when wanting to restrict the access rights of a user, the correspondingly encrypted adapter data for this user may be removed from the system.

Controlling access to nodes and the corresponding directories and files may, in one embodiment, exemplarily be realized by using keys which are used for encrypting the metadata of the nodes also for encrypting the corresponding edges. Since the users having access to these nodes also have access to the corresponding key, the users may also access the keys necessitated to access the metadata of the edges.

In another embodiment, the elements of edges and nodes of the file system hierarchy are sorted relative to the users having access to the corresponding elements. For each node v, a quantity U(v) is defined which refers to the quantity of users having access to the metadata of the node v. (k_{E}^{U(v)}, k_{D}^{U(v)}) is then defined to be the access key pair (k_{E}^{e}, k_{D}^{e}) used to encrypt the metadata of the edges which have v as a successor node. These keys which are encrypted using the user key k_{E}^{u} for each user uεU(v) are stored.

Thus, in this embodiment, a user uεU(v) wanting to read the metadata of the edge e has to know k_{D}^{U(v)}. When u knows this key, he may also access neighboring nodes v′, as long as the corresponding quantity U(v′) does not change. When the file system graph consists of long sub-graphs connected to one another which have the same user quantity U(v′), this may decrease the number of storage accesses significantly.

Since the access key pair (k_{E}^{e}, k_{D}^{e}) depends on the access user quantity (U)v, in one embodiment, two encrypted versions of the edge metadata quantity Me are introduced for each edge e=(v,v′), wherein one version is encrypted using the key pair (k_{E}^{U(v)}, k_{D}^{U(v)}) and the other one using the key pair (k_{E}^{U(v′)}, k_{D}^{U(v′(}), wherein the first key pair is used for the edge in the edge direction, i.e. from v to v′, and wherein the second key pair is used for the edge opposite to the edge direction, i.e. from v′ to v.

Cooperation between the node metadata and the edge metadata will be discussed again in greater detail below.

With regard to the hierarchy of the file system, the actual hierarchy information are deposited in the encrypted metadata and, thus, cannot be seen. This means that an attacker first has to compromise the underlying cryptographic method before getting the information.

By skillfully selecting the cryptographic structure, the system may be employed widely and extended by adding information. The data may exemplarily be distributed redundantly and consistently with little additional expenditure.

The design of this system additionally allows introducing so-called honey files. These are files which additionally hide the structure of the system by being introduced at most different locations in a randomized manner, while being visible only for non-authorized users. Thus, it may, for example, be achieved that an eavesdropping attacker establishes misleading structural information.

The tasks of a directory system or a crypto container in this concept may be transferred completely to the metadata level and (depending on the action) be executed using loose coupling.

Further algorithms will be shown below which are also used when operating with the system and serve for a better understanding. Cleaning algorithms for removing superfluous ciphers are omitted for reasons of clarity.

In one embodiment, adding a directory or a file may be done as follows:

Let v be an existing, opened directory (Mv is available) in which only a sub-directory (or file) v′ is to be created which the user u is to have access rights to. Some embodiments are exemplarily implemented in accordance with the following pseudo code:

```
appendFileOrDirectory (v′, v, u)
begin
  create new Mₑ_{^{v}}′, M_{v′}, (k_{E}^{U(v′)}, k_{D}^{U(v′)}), (k_{E}^{v′}, k_{D}^{v′}).
  add (k_{E}^{v}, k_{D}^{v}) and (k_{E}^{v′}, k_{D}^{v′}) to Mₑ_{^{v′}}
  encrypt v′ using k_{E}^{v′} and store ciphertext at desired location r(i(v′))
  run E(k_{E}^{e}^{^{v′}}, E(k_{E}^{U(v′)}, Mₑ_{^{v′}})). E(k_{E}^{u}, r(i(v)), (k_{E}^{v′},k_{D}^{v′})). E(k_{E}^{v′}, M_{v′})
    and E(k_{E}^{u}, (k_{E}^{U(v′)}, k_{D}^{U(v′)}))
  add (k_{E}^{e}^{^{v′}}, k_{D}^{e}^{^{v′}}) to Mᵥ
end
```

When generating the metadata, further contents of the metadata are assumed to have been generated as well.

In accordance with an embodiment, shifting a directory or a file may be realized as follows:

Let v be an existing, opened directory (Mv is available) with a sub-directory (or a file contained therein) v′ which the user u has access rights to. Let further w be an existing, opened directory (Mw is available) which v′ is to be shifted to. The user u is also to have access to v′. When v′ is a directory, its content is to be shifted as well. Some embodiments are exemplarily implemented in accordance with the following pseudo code:

```
moveFileOrDirectory (v, v′, w, u)
begin
  remove (k_{E}^{e}^{^{v′}}), k_{D}^{e}^{^{v′}}) from Mᵥ
  remove (k_{E}^{v}, k_{D}^{v}) from Mₑ^{v′}
  add (k_{E}^{e}^{^{v′}} , k_{D}^{e}^{^{v′}}) to M_{w}
  add (k_{E}^{w}, k_{D}^{w}) to Mₑ_{^{v′}}
end
```

The underlying data are not affected.

In one embodiment, adding access rights may be realized as follows:

Let v be any node in the file system graph. A user u is to obtain access rights to v. In some embodiments, granting rights is implemented in accordance with the following pseudo code, for example:

```
addRights (v, u)
begin
  determine adapter Aᵥ^{u}
  do create key pair (k_{E}^{U(v)}, k_{D}^{U(v)})
  encrypt Aᵥ^{u} with user key k_{E}^{u}
  for all vertices v′ in the subtree of v do
    determine (k_{E}^{U(v′)}, k_{D}^{U(v′)})
    encrypt (k_{E}^{U(v′)}, k_{D}^{U(v′)}) with k_{E}^{u}
  end
end
```

It is assumed here that the access rights to the parent elements of v are not to be granted. Otherwise, the algorithm may of course also be provided with a parent element.

A restriction of the rights with regard to the nodes of the sub-tree with the root v is not assumed here either. If u is not to get access to a node v′, the encryption of (k_{E}^{U(v′)}, k_{D}^{U(v′)}) is omitted.

Another assumption here is that this is about an algorithm with administrator rights. The algorithm may thus decrypt existing graph elements. This may be restricted in a trivial manner. However, no restriction has been done here for the sake of better understanding.

In accordance with an embodiment, removing access rights may be implemented as follows:

When a user u has access to a node v of the file system graph, the following algorithm may be applied for withdrawing access. Some embodiments are, for example, implemented in accordance with the following pseudo code:

```
removeRights (v, u)
begin
  if E(k_{E}^{u}, Aᵥ^{u}) exists
    remove E(k_{E}^{u}, Aᵥ^{u})
  if E(k_{E}^{u}, (k_{E}^{U(v)}, k_{D}^{U(v)})) exists
    remove E(k_{E}^{u}, (k_{E}^{U(v)}, k_{D}^{U(v)}))
  for all vertices v′ in the subtree of v do
    removeRights (v′, u)
  end
end
```

Again, it is assumed that access to the nodes of the sub-tree with the root v is also to be prohibited and the algorithm has administrative rights.

The trick here is that a trusted environment is used for cryptographic operations, thereby ensuring that a user is not able to memorize the contents of the ciphers. However, when not being able to memorize the contents, metadata cannot be decrypted. When buffering keys in a trusted environment, a timer integrated there provides for the keys to be “forgotten” in regular periods. This is why speedily withdrawing rights may also be realized by using buffering.

Although having described some aspects in connection with a device, it is obvious that these aspects also represent a description of the corresponding method such that a block or element of a device is to be understood also to be a corresponding method step or a feature of a method step. In analogy, aspects having been described in connection with or as a method step, also represent a description of a corresponding block or detail or feature of a corresponding device. Some or all of the method steps may be performed by a hardware apparatus (or using a hardware apparatus), such as, for example, a microprocessor, a programmable computer or an electronic circuit. In some embodiments, some or more of the most important method steps may be executed by such an apparatus.

Depending on specific implementation requirements, embodiments of the invention may be implemented in hardware or software or at least partly in hardware or at least partly in software. The implementation may be using a digital storage medium, like a floppy disk, DVD, BluRay disk, CD, ROM, PROM, EPROM, EEPROM or Flash Memory, a hard disk drive or another magnetic or optical storage onto which electronically readable control signals are stored which may cooperate or cooperate with a programmable computer system such that the respective method will be executed. Thus, the digital storage medium may be computer-readable.

Some embodiments in accordance with the invention thus include a data carrier comprising electronically readable control signals which are able to cooperate with a programmable computer system such that one of the methods described herein will be performed.

Generally, embodiments of the present invention may be implemented to be a computer program product having a program code, the program code being operative to perform one of the methods when the computer program product runs on a computer.

The program code may, for example, be stored on a machine-readable carrier.

Other embodiments include the computer program for performing one of the methods described herein, the computer program being stored on a machine-readable carrier. In other words, an embodiment of the inventive method is a computer program comprising a program code for performing one of the methods described herein when the computer program runs on a computer.

Thus, another embodiment of the inventive method is a data carrier (or a digital storage medium or a computer-readable medium) onto which the computer program for performing one of the methods described herein is recorded. The data carrier or the digital storage medium or the computer-readable medium is typically real and/or non-volatile.

Another embodiment of the inventive method thus is a data stream or a sequence of signals representing the computer program for performing one of the methods described herein. The data stream or the sequence of signals may exemplarily be configured to be transferred via a data communication connection, exemplarily via the Internet.

Another embodiment includes processing means, exemplarily a computer or a programmable logic device, which is configured or adapted to perform one of the methods described herein.

Another embodiment includes a computer onto which is installed the computer program for performing one of the methods described herein.

Another embodiment in accordance with the invention includes a device or a system configured to transfer a computer program for performing at least one of the methods described herein to a receiver. The transfer may exemplarily take place electronically or optically. The receiver may, for example, be a computer, a mobile device, a storage device or a similar device. The device or the system may exemplarily include a file server for transferring the computer program to the receiver.

In some embodiments, a programmable logic device (exemplarily a field-programmable gate array, FPGA) may be employed for performing some or all of the functionalities of the methods described herein. In some embodiments, a field-programmable gate array may cooperate with a microprocessor in order to perform one of the methods described herein. Generally, in some embodiments, the methods are performed on the part of any hardware device. This may be universally employable hardware, like a computer processor (CPU), or hardware specific for the method, like an ASIC.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

Even when some of the following claims refer back to only a single claim, the disclosure of the application nevertheless also includes any combination conceivable of the following claims.

1. A device for accessing metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, the device comprising:
an interface and
a processor,
wherein the interface is configured to load encrypted edge metadata of an edge of the plurality of edges from the storage,
wherein the processor is configured to decrypt the encrypted edge metadata of the edge of the plurality of edges in order to acquire decrypted edge metadata of the edge of the plurality of edges, comprising at least a node decryption key of a node of the plurality of nodes and information on a storage location of the encrypted node metadata of the node of the plurality of nodes in the storage, the node of the plurality of nodes being the predecessor node or successor node of the edge of the plurality of edges,
wherein the interface is configured to load the encrypted node metadata of the node of the plurality of nodes from the storage using the information on the storage location of the encrypted node metadata of the node of the plurality of nodes, and
wherein the processor is configured to decrypt the encrypted node meta data of the node of the plurality of nodes using the node decryption key of the node of the plurality of nodes in order to acquire decrypted node metadata of the node of the plurality of nodes.

2. The device in accordance with claim 1,
wherein the device additionally comprises an output unit which is a screen unit, a sound output unit or a printer,
wherein the decrypted node metadata of the node of the plurality of nodes comprise a directory name of the directory which the node is associated to, or a file name of the file the node is associated to, and
wherein the output unit is configured to output the directory name or the file name.

3. The device in accordance with claim 1,
wherein the decrypted node metadata of the node of the plurality of nodes comprise information on a storage location of the file which the node is associated to,
wherein the interface is configured to load, using the information on the storage location of the file which the node of the plurality of nodes is associated to, the file which the node of the plurality of nodes is associated to from the storage, and
wherein the processor is configured to output the file which the node of the plurality of nodes is associated to.

4. The device in accordance with claim 1,
wherein the device is configured to acquire the decrypted edge metadata of the edge of the plurality of edges by the processor being configured to decrypt further encrypted node metadata of another node of the plurality of nodes in order to acquire further decrypted node metadata, wherein the further node is either the predecessor node or the successor node of the edge of the plurality of edges, wherein the further decrypted metadata comprise at least an edge decryption key of the edge of the plurality of edges and information on a storage location of the encrypted edge metadata of the edge of the plurality of edges in the storage,
wherein the interface is configured to load the encrypted edge metadata of the edge of the plurality of edges from the storage using the information on the storage location of the encrypted edge metadata of the edge of the plurality of edges, and
wherein the processor is configured to decrypt the encrypted edge metadata of the edge of the plurality of edges using the edge decryption key of the edge of the plurality of edges in order to acquire the decrypted edge metadata of the edge of the plurality of edges.

5. The device in accordance with claim 4,
wherein the interface is configured to load an authorization key for the edge of the plurality of edges when a user is authorized to access the successor node of the edge of the plurality of edges, or wherein the interface is configured to load an authorization key for the edge of the plurality of edges when the user is authorized to access the predecessor node of the edge of the plurality of edges, and
wherein the processor is configured to decrypt the encrypted edge metadata using the edge decryption key and the authorization key of the edge of the plurality of edges in order to acquire the decrypted edge metadata of the edge of the plurality of edges.

6. The device in accordance with claim 5,
wherein the interface is configured not to load an authorization key for the edge of the plurality of edges when the user is not authorized to access the successor node of the edge of the plurality of edges, or wherein the interface is configured not to load an authorization key for the edge of the plurality of edges when a user is not authorized to access the predecessor node of the edge of the plurality of edges, and
wherein the processor is configured not to decrypt the encrypted edge metadata of the edge of the plurality of edges when the user is not authorized to access the successor node of the edge of the plurality of edges, or wherein the processor if configured not to decrypt the encrypted edge metadata of the edge of the plurality of edges when the user is not authorized to access the predecessor node of the edge of the plurality of edges.

7. The device in accordance with claim 5, wherein the processor is configured to decrypt the encrypted edge metadata of the edge of the plurality of edges by the processor decrypting the encrypted edge metadata using the edge decryption key of the edge of the plurality of edges in order to acquire first encrypted intermediate data of the edge of the plurality of edges, and by the processor decrypting the first encrypted intermediate data using the authorization key of the edge of the plurality of edges in order to acquire the decrypted edge metadata of the edge of the plurality of edges.

8. The device in accordance with claim 5, wherein the processor is configured to decrypt the encrypted edge metadata of the edge of the plurality of edges by the processor decrypting the encrypted edge metadata using the authorization key of the edge of the plurality of edges in order to acquire second encrypted intermediate data of the edge of the plurality of edges, and by the processor decrypting the second encrypted intermediate data using the edge decryption key of the edge of the plurality of edges in order to acquire the decrypted edge metadata of the edge of the plurality of edges.

9. The device in accordance with claim 1, wherein the storage is a non-volatile storage.

10. A system realizing access to metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, the system comprising:
one or more devices in accordance with claim 1, and
a storage,
wherein the interface of each of the one or more devices is configured to load encrypted edge metadata of an edge of the plurality of edges of the metadata information from the storage,
wherein the processor of each of the one or more devices is configured to decrypt the encrypted edge metadata of the edge of the plurality of edges in order to acquire decrypted edge metadata of the edge of the plurality of edges, comprising at least a node decryption key of a node of the plurality of nodes and information on a storage location of encrypted node metadata of the node of the plurality of nodes in the storage, the node of the plurality of nodes being the predecessor node or successor node of the edge of the plurality of edges,
wherein the interface of each of the one or more devices is configured to load the encrypted node metadata of the node of the plurality of nodes from the storage using the information on the storage location of the encrypted node metadata of the node of the plurality of nodes, and
wherein the processor of each of the one or more devices is configured to decrypt the encrypted node metadata of the node of the plurality of nodes using the node decryption key of the node of the plurality of nodes in order to acquire decrypted node metadata of the node of the plurality of nodes.

11. The system in accordance with claim 10, wherein the system comprises two or more devices in accordance with claim 1 as the one of more devices.

12. The system in accordance with claim 11,
wherein the storage comprises two or more sub-storages,
wherein the system additionally comprises two or more casings, each of the two or more casings enclosing precisely one of the two or more sub-storages of the storage, and
wherein at least node metadata of at least one of the plurality of nodes of the metadata information or at least edge metadata of at least one of the plurality of nodes of the metadata information are stored on each of the two or more sub-storages.

13. The system in accordance with claim 12, wherein each of the two or more casings additionally encloses precisely one of the at least two devices.

14. The system in accordance with claim 12, wherein, in at least one of the two or more sub-storages, edge metadata of one of the plurality of edges of the metadata information are stored in an encrypted manner, comprising information on a storage location of node metadata of one of the plurality of nodes, wherein there node metadata are stored in another one of the two or more sub-storages in an encrypted manner.

15. A non-volatile storage, a plurality of nodes and a plurality of edges defining a hierarchy of a file system, each edge of the plurality of edges being defined by a predecessor node and a successor node from the plurality of nodes each, each node of the plurality of nodes being associated to either a directory of the file system or a file of the file system, the non-volatile storage comprising:
a plurality of storage cells, and
a storage interface for accessing the plurality of storage cells,
wherein edge metadata are stored in the non-volatile storage for each edge of the plurality of edges in an encrypted manner,
wherein node metadata are stored in the non-volatile storage for each node of the plurality of nodes in an encrypted manner,
wherein the edge metadata of each edge of the plurality of edges comprise, for at least one node of the plurality of nodes which is the predecessor node or the successor node of this edge, at least a node decryption key for decrypting the node metadata of this node and information on a storage location of the node metadata of this node in the non-volatile storage, and
wherein the node metadata of each node of the plurality of nodes comprise, for at least one edge of the plurality of edges for which this node is the predecessor node or the successor node, at least an edge decryption key for decrypting this edge and information on a storage location of the encrypted edge metadata of this edge in the non-volatile storage.

16. A method for accessing metadata information of a file system, a plurality of nodes and a plurality of edges defining a hierarchy of the file system, each edge of the plurality of edges being defined by a predecessor node and a successor node from the plurality of nodes each, each node of the plurality of nodes being associated to either a directory of the file system or a file of the file system, the method comprising:
loading encrypted edge metadata of an edge of the plurality of edges from a storage,
decrypting encrypted edge metadata of the edge of the plurality of edges in order to acquire decrypted edge metadata of the edge of the plurality of edges, comprising at least a node decryption key of a node of the plurality of nodes and information on a storage location of encrypted node metadata of the node of the plurality of nodes in the storage, wherein the node of the plurality of nodes is the predecessor node or the successor node of the edge of the plurality of edges,
loading the encrypted node metadata of the node of the plurality of nodes from the storage using the information on the storage location of the encrypted node metadata of the node of the plurality of nodes, and
decrypting the encrypted node metadata of the node of the plurality of nodes using the node decryption key of the node of the plurality of nodes in order to acquire decrypted node metadata of the node of the plurality of nodes.

17. A non-volatile computer-readable medium comprising a computer program, the computer program implementing a method in accordance with claim 16 when the computer program is executed on a computer.
